(19) United States
(12) Patent Application Publication
(10) Pub. No.: US 2025/0165993 A1
(43) Pub. Date: May 22, 2025

(54) SYSTEMS AND METHODS FOR HUMAN-IN-THE-LOOP TRAINING OF A MACHINE LEARNING MODEL FOR EXTRACTING TARGETS FROM RECORDS

(71) Applicant: Capital One Services, LLC, McLean, VA (US)

(72) Inventors: Leeyat Bracha TESSLER, Arlington, VA (US); John MARTIN, Brooklyn, NY (US); Dexter FERGUSON, Catonsville, MD (US); Jerry WU, New York, NY (US)

(73) Assignee: Capital One Services, LLC, McLean, VA (US)

(21) Appl. No.: 18/516,093

(22) Filed: Nov. 21, 2023

(51) Int. Cl. G06Q 30/0201; G06N 5/022; G06Q 30/0601

(52) U.S. Cl. CPC G06Q 30/0201; G06N 5/022; G06Q 30/0633

(57) ABSTRACT

Systems and methods for training a machine learning model by extracting targets from records are disclosed. A method includes receiving data packets including data associated with previous interactions of a user, determining at least one party to the previous interactions with whom the user interacted at a level above a threshold, and comparing the at least one party to a plurality of parties identified in a target database to identify at least one potential target, for each potential target, determining a respective target metric by inputting the data packets into a machine learning model, providing an identification of the at least one potential target, with reference to the respective target metrics, to a user device associated with the user, receiving, via the user device, feedback regarding the identification, and training the machine learning model based on the feedback.

### TECHNICAL FIELD

Various embodiments of this disclosure relate generally to systems and methods of training a machine learning model and, more particularly, to systems and methods for determining a target metric related to a party to interactions with a user.

### BACKGROUND

Many people do not know where friends and family often shop and therefore do not know where to purchase gifts for their friends and family. In some cases, gift cards from a generic retailer become the default gift due to the lack of knowledge of more personalized options. Manually creating a wish list of desired gifts may be time-consuming, unproductive, and may present an undesirable image to others of materialism and/or ingratitude. Furthermore, receiving an item that was specifically requested may not have the same positive effect as receiving a surprise gift item acquired with thought and care.

This disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for training a machine learning model by extracting one or more targets from records. A method may include receiving, by at least one processor, data packets including data associated with previous interactions of a first user. The method may further include determining, by the at least one processor, at least one party to the previous interactions with whom the first user interacted at a level above a threshold, and comparing the at least one party to a plurality of parties identified in a target database to identify at least one potential target. The method may also include, for each of the at least one potential targets, determining, by the at least one processor, a respective target metric by inputting the data packets into a machine learning model, and providing, by the at least one processor, an identification of the at least one potential target, with reference to the respective target metrics, to a user device associated with the first user. The method additionally includes receiving, via the user device, feedback regarding the identification, and training the machine learning model based on the feedback.

In one aspect, a system for training a machine-learning model by extracting one or more targets from records is disclosed. The system may include a memory storing instructions and a processor operatively connected to the memory and configured to execute the instructions to perform operations. The operations may include receiving data packets including data associated with previous interactions of a first user, determining at least one party to the previous interactions with whom the first user interacted at a level above a threshold, and comparing the at least one party to a plurality of parties identified in a target database to identify at least one potential target. The operations may further include, for each of the at least one potential targets, determining a respective target metric by inputting the data packets into a machine-learning model, and providing an identification of the at least one potential target, with reference to the respective target metrics, to a user device associated with the first user. The operations may also include receiving, via the user device, feedback regarding the identification, and training the machine-learning model based on the feedback.

In another aspect, a non-transitory computer readable medium storing instructions is disclosed which, when executed by one or more processors, cause the one or more processors to perform operations for training a machine-learning model by extracting one or more targets from records. The operations may include receiving data packets including data associated with previous interactions of a first user, determining at least one party to the previous interactions with whom the first user interacted at a level above a threshold, and comparing the at least one party to a plurality of parties identified in a target database to identify at least one potential target. The operations may further include, for each of the at least one potential targets, determining a respective target metric by inputting the data packets into a machine-learning model, and providing an identification of the at least one potential target, with reference to the respective target metrics, to a user device associated with the first user. The operations also include receiving, via the user device, feedback regarding the identification, training the machine-learning model based on the feedback, providing the at least one potential target to a second user device associated with a second user, receiving an indication from the second user device that the second user has visited a website associated with the at least one potential target, and further training the machine-learning model based on the indication.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates an environment for training a machine-learning model by extracting one or more targets from records, according to one or more embodiments.

FIG. 2 is a flowchart depicting an example method for training a machine learning model by extracting one or more targets from records, according to one or more embodiments.

FIG. 3 is a flow chart depicting how a machine learning model may be trained, in accordance with one or more embodiments.

FIG. 4 depicts a simplified functional block diagram of a computer that may be configured as a device for executing the methods disclosed here, according to exemplary embodiments of the present disclosure.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a user may log into a website hosted by a system that manages, maintains, or has access to records related to the user's interactions with third parties. In some cases, the system may be operated by a credit card company that has issued a credit card to the user. The user may click a button on the website to create a wish list based on credit card interaction (e.g., transaction) data with third parties (e.g., merchants). The system may generate a shareable list of third parties by first filtering the third parties to only include third parties with certain merchant category codes (MCCs) that indicate the third parties are likely to offer gift items or gift cards, to only include third parties that the user interacts with at above a threshold level, and/or prune out third parties based on other criteria such as availability of gifting options, etc.

For instance, the system may periodically scrape websites associated with the third parties from the interactions with the user to determine whether the third parties offer gifting options. For example, the system may determine that a third party includes an option during checkout to identify an item being purchased as a gift. The system may also scan websites to determine whether third parties offer gift cards for purchase. The system may, using a machine learning model, determine a metric (e.g., a score or rating) indicating how easy (e.g., convenient, user-friendly, efficient, etc.) it is to acquire a gift from a particular third party.

The system may learn from user behavior and train the machine learning model based on user feedback and other inputs. For example, upon receiving the list of merchants and their respective metrics from the system, the user may remove certain third parties from the list indicating third parties from whom the user does not wish to receive gifts. The user may also interact with the system by indicating specific items or types of times that are especially of interest to the user as a gift (e.g., via an open text field). Such input may be used to refine the machine learning model and/or refine the list. For example, interactions, behaviors, etc. may be used to train the machine learning model so as to be specifically tuned to the user.

The user may share this list with second user (e.g., a friend or family member). The second user may use the system to follow direct links to websites associated with the third parties listed on the wish list. The clicks on direct links may be further inputs for the machine learning model, allowing the model to be more effective in determining a metric for “giftability.”

In embodiments, a system according to one or more aspects of the present disclosure (e.g., target metric determination system) enables a user to generate a wish list and share that wish list with other users. In some embodiments, such actions may be performed within a single system, which is not possible using conventional methods and systems. For instance, because the system enables a user to automatically create a wish list of third parties with whom the user has interacted while working with a single system instead of using multiple systems, various embodiments of the system of the present disclosure reduce required processing power, memory, and communication resources needed to facilitate generating wish lists and metrics for giftability of a third party. Such a target metric determination system may result in less data transfer and data bandwidth usage for a computer/communication system. In other words, the target metric determination system may result in less required processing power and communication bandwidth in comparison to conventional systems. Additionally, in view of the foregoing, the target metric determination system may result in more user-friendly, consistent, reliable, accurate, and efficient method for generating lists of giftable third parties and determining respective metrics associated with each third party.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used herein, the term “determining” or “evaluating” encompasses a wide variety of actions. For example, “determining” and “evaluating” may include calculating, computing, processing, deriving, investigating, looking up (e.g., looking up in a table, a database or other data repository, or another data structure), ascertaining, and/or the like. Also, “determining,” and “evaluating” may include receiving (e.g., receiving information), accessing (e.g., accessing data in a data repository), and/or the like. Also, “determining” may include resolving, selecting, choosing, establishing, and the like.

As used herein, the terms “element,” “module,” “component,” and “system” may refer to a computer-related entity, either hardware, a combination of hardware and software, software, or software in execution. For example, a module may be, but is not limited to being, a machine-executable process running on a processor, a processor, an object, a thread of execution, a machine-executable program, and/or a computer. By way of illustration, both a process running on a server and the server may be a module or a component. One or more modules or components may reside within a process and/or thread of execution. In some implementations, a module may be localized on one computer and/or distributed among two or more computers.

Various aspects or features will be presented herein in terms of systems that may include a number of devices, components, modules, and the like. It is to be understood and appreciated that the various systems may include additional devices, components, modules, etc. and/or may not include all of the devices, components, modules, etc., discussed in connection with the figures. A combination of these approaches may also be used.

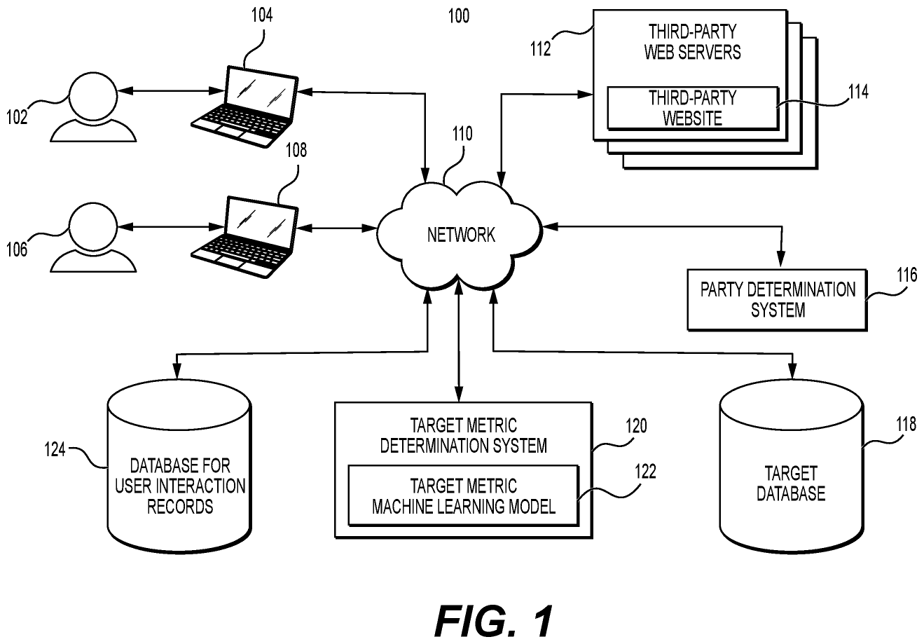

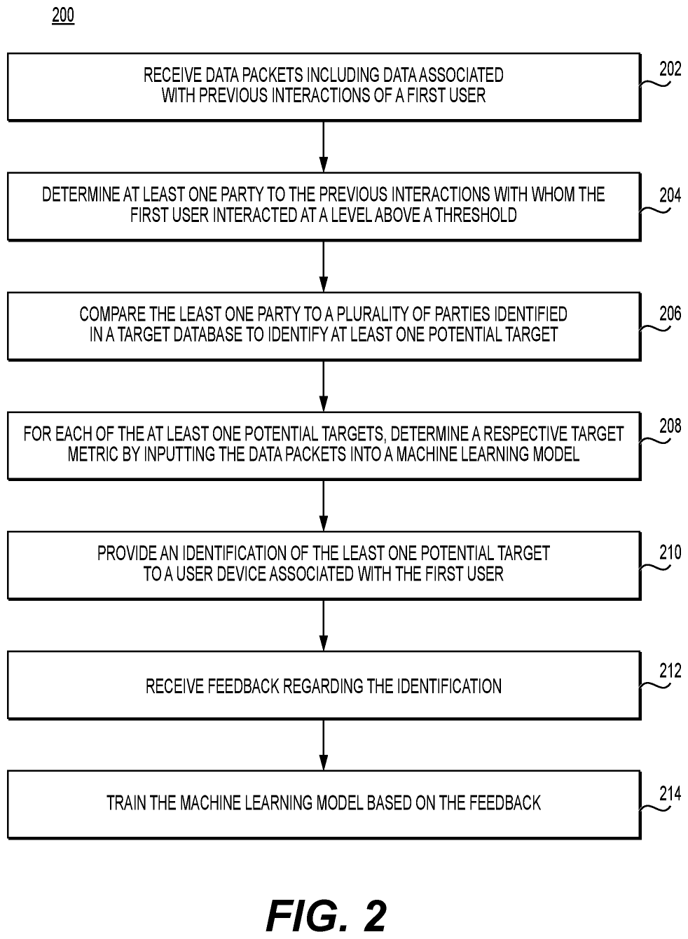

Referring to FIGS. 1-4, aspects are depicted with reference to one or more components and one or more methods that may perform the actions of functions described herein. Although the operations described below in FIG. 2 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing he described actions of functions.

FIG. 1 illustrates an environment 100 for training a machine-learning model by extracting one or more targets from records, according to one or more embodiments. Environment 100 of FIG. 1 depicts users 102, 106, user devices 104, 108, third-party web servers 112, a party determination system 116, a target database 118, a target metric determination system 120, and a database 124 for user interaction records. All or some of the components of environment 100 may be connected to each other via network 110, and/or in some cases may be directly connected to each other, bypassing network 110. Components of the environment 100 may communication and/or be arranged in any suitable manner.

Third-party web servers 112 may host one or more third-party websites 114. Each third-party web server 112 may include one or more third-party electronic devices (e.g., computing devices or groups of computing devices), such as individual servers or groups of servers operating in a distributed manner. A third-party web server 112 may communicate with other components of environment 100 including party determination system 116, target metric determination system 120, or user devices 104, 108 via network 110. For example, third-party web servers 112 may receive requests for data from user device 104 or target metric determination system 120. Third-party web servers 112 may send the requested data via the network 110 to the user device 104 or target metric determination system 120. In some examples, a user 102 may interact with third-party web servers 112 via user device 104. To facilitate the interaction with the user, the third-party web servers 112 may present one or more third-party websites 114 to user device 104. In some embodiments, third-party web servers 112 may host third-party websites created and administered by parties to interactions with user 102. While the term “website” is used herein, the third-party website 114 may be a user interface other than a website or a webpage, such as a user interface of a client-side application executing on the user device 104, such as the user interface of an app executing on a laptop or a smartphone of the user and communicating with third-party web servers 112.

As illustrated in FIG. 1, a user 102 may be a human user that interfaces with user device 104, for example, to communicate with other components of environment 100, such as target metric determination system 120. Similarly, a second user 106 may interface with a second user device 108, for example, to communicate with components of environment 100 including target metric determination system 120. Although FIG. 1 illustrates two users and two user devices, environment 100 may include any number of users that each interact with environment 100 using corresponding user devices.

Database 124 for user interaction records may store data related to interactions between user 102 and various third parties. Such interactions may include credit card transactions indicating a purchase of goods or services by user 102 from a third party. User interaction records stored in database 124 may include, for each interaction, an interaction identifier (e.g., identification number), a type of interaction (e.g., deposit, withdrawal, purchase, refund, etc.), a time and a date of the interaction, an identity of the third party (e.g., a name of the card acceptor, a merchant identity number (MID), etc.), a type of the third party (e.g., a merchant category code (MCC)), an amount of resources (e.g., money) that was exchanged between user 102 and the third party, and an identity of a terminal machine used in the interaction (e.g., terminal identity number (TID)). Database 124 may receive interaction data from a party (e.g., from a terminal belonging to the party) to an interaction with a user (e.g., user 102). In some cases, database 124 may receive interaction data from a credit card issuer or a service that manages (e.g., issues) a credit card for user 102. Database 124 may also be managed and maintained by the credit card issuer.

Party determination system 116 may determine one or more parties (e.g., merchants) with whom user 102 has interacted (e.g., transacted), and in some embodiments may further determine whether user 102 has interacted with the one or more parties at a level above a threshold. For example, party determination system 116 may receive data including one or more interactions from database 124 including interactions between user 102 and various parties. Party determination system 116 may extract one or more records from database 124 identifying one or more parties to interactions with user 102. Party determination system 116 may determine a number of interactions between user 102 and a particular party to determine whether user 102 interacted with the particular party at a level above a threshold. The threshold may be predetermined as a total number of interactions or a number of interactions within a defined time period (e.g., within a past year, quarter, month, etc.). If party determination system 116 determines that user 102 interacted with a particular party at a level above a threshold, party determination system 116 may communicate with target database 118 to compare the particular party to a plurality of parties included in the target database 118 to identify a potential target party. A potential target party may include a party through which individuals may acquire items (e.g., gifts) for others.

The data including one or more interactions received from database 124 may include MCCs associated with a party to each interaction. Before comparing a particular party to parties identified in the target database 118 to identify a potential target, party determination system 116 may remove the particular party from consideration as a potential target by determining that the MCC associated with the particular party is not of a predetermined type. An MCC associated with a party may not be of a predetermined type, e.g. because the MCC may indicate that individuals are not likely to purchase gifts from the party. For example, an MCC associated with a party may indicate that the party is a physician or a dentist. Physicians and dentists may be unlikely to offer goods that may be purchased as gifts for others, and may also be unlikely to offer gift cards. Accordingly, that MCC may be noted as not preferable for gifting, and in this example, any party with an MCC identifying the party as a physician (e.g., clinics, hospitals, doctor offices, etc.) or a dentist may be screened and removed from consideration as a potential target. MCCs may indicate a party to be a retailer, restaurant, ticketing company, etc. where gifts or gift cards may be acquired. A party with an MCC indicating the party may be one where a gift may be purchased may be compared with parties included in target database 118. Likelihoods of MCCs or categories of MCCs for offering products usable as gifts may be stored in the target database 118, and may be, for example, predetermined, determined via a machine learning model configured to analyze interaction data from one or more users, or any other suitable technique.

Following the comparison between a potential party and the parties stored in target database 118, party determination system 116 may determine whether the potential party should be added to target database 118, e.g., upon determining that the potential target party is not already in the target database 118. In some cases, target database 118 may be updated to include a number of instances where the potential party was considered to be added to the target database 118. If target database 118 does not already include the potential target party, the potential target party may be added to target database 118. Target database 118 may include data related to target parties including an identity and type of parties to interactions with user 102, or any other user. Target database 118 may further include additional details related to parties to interactions with user 102 or with any other user. In some cases, target database 118 may include data received from interactions from several users in addition to user 102.

Target metric determination system 120 may determine a metric related to each of the target parties stored in target database 118. The determined metric may include a “giftability” score, which may indicate an ease (e.g., convenience, efficiency, and effectiveness) with which an individual (e.g., user 106) may acquire an item (e.g., a gift) intended for another individual (e.g., user 102).

Target metric determination system 120 may periodically communicate with third-party web servers 112 to scrape third-party websites 114 (e.g., via a browser extension) associated with one or more target parties of target database 118. Data obtained by target metric determination system 120 from one or more third-party websites 114 may be used to determine the target metric. For example, target metric determination system 120 may detect whether a target party offers “gifting” options (e.g., an indication at checkout that an item to be purchased is a gift). As another example, target metric determination system 120 may determine whether a target party offers gift cards or gift certificates for purchase. As further examples of how the target metric may be determined, target metric determination system 120 may determine whether a target party offers a diverse selection of goods and/or services and a quality of products and/or services offered (e.g., by parsing ratings or reviews). The target metric determination system 120 may further determine whether the target party offers gift wrapping and/or packaging and personalization options (e.g., engraving, monogramming, custom colors or designs, or personalized messages). Additionally, target metric determination system 120 may determine customer service scores and assess convenience. In some embodiments, when determining a target metric, target metric determination system 120 may access a third-party review service to collect and analyze data related to a particular target party.

Target metric determination system 120 may include one or more lists of target parties that have been identified as illicit (e.g., illegal or inappropriate) and may take steps to remove identified illicit parties from target database 118 and restrict illicit parties from being added to target database 118. In some cases, user 102 may identify target parties as illicit.

Target metric determination system 120 may determine a target metric using target metric machine learning model 122. In some cases, data received from user 102 (e.g., via user device 104) are used as inputs for target metric machine learning model 122. Additionally, data received from user 102 and/or user 106 may be used to train, re-train, tune, and/or update target metric machine learning model 122. For example, one or more potential target parties determined by party determination system 116, stored in target database 118, along with respective target metrics determined by target metric determination system 120 may be provided to user device 104. User 102 may provide feedback regarding the potential target parties along with their respective target metrics to target metric determination system 120. The feedback from user 102 may include an indication that one or more identified potential target parties should not be included as a target party with regard to “giftability.” Other feedback may include an indication that the target metric is inaccurate in the view of user 102. For example, user 102 may believe that the target metric should be higher or lower. Target metric machine learning model 122 may then be trained (e.g., re-trained or updated) based on the feedback received from user 102.

Additional data from user 106 may be used as inputs for training, re-training, and/or updating target metric machine learning model 122. For example, user 102 may send a list of target parties to user 106, indicating to user 106 that the list is representative of parties from whom user 102 would like to receive goods and/or services as gifts. User 106 may then have an option of selecting hyperlinks to visit websites associated with the target parties (e.g., one or more third-party websites 114). The selection of hyperlinks by user 106 may be recorded and transmitted to target metric determination system 120 as inputs for training target metric machine learning model 122.

Second user 106 may receive (e.g., via second user device 108) a list of potential targets from target database 118 along with respective target metrics determined by target metric determination system 120 for each potential target. In some embodiments, target metric determination system 120 may require approval from user 102 before sending the list of potential targets related to interactions of user 102. For example, user 102 may request that a list of potential targets be generated based on interactions of the user 102 and third parties. Following the generation of the list of potential targets by party determination system 116 and the determination of target metrics by target metric determination system 120, user 102 may approve the list and target metrics, thus allowing the list of potential targets to be shared. User 102 may further provide contact information (e.g., name, email address, online username, etc.) for user 106 allowing the list to be shared with user 106. User 106 may use the list of potential targets along with the respective target metrics to acquire a gift for user 102 from a preferred target party. In another embodiment, user 106 may submit a request a request via the second user device 108 to the target database 118 for the list of potential targets. The request may cause the target database 118 to prompt the user 102 for approval, authentication, or the like, and/or may compare an identification of the user 106 against a list of users approved by the user 102, etc. In an exemplary use case, the user 102 may have approved an opt-in option to “Let your friends know where to shop for you,” whereby the user 106 may be a previously confirmed “friend” or contact of the user 102. In other embodiments, any suitable interaction process between the user 102 and user 106 may be used.

One or more of the components in FIG. 1 may communicate with each other and/or other systems, e.g., across network 110. In some embodiments, network 110 may connect one or more components of environment 100 via a wired connection, e.g., a USB connection between user device 104 and database 124 or 118. In some embodiments, network 110 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, party determination system 116 may be integrated in target metric determination system 120. In another example, target metric determination system 120 may include target database 118 and/or database 124 for user interaction records. In some embodiments, operations or aspects of one or more of the components discussed above may be distributed amongst one or more other components. Any suitable arrangement and/or integration of the various systems and devices of the environment 100 may be used.

FIG. 2 depicts an exemplary method 200 for determining a target metric using a machine learning model, according to one or more embodiments. Method 200 may be performed by one or more components of the environment 100 of FIG. 1, according to some embodiments of the disclosure. For example, one or more steps of method 200 may be performed by target metric determination system 120 or party determination system 116 of FIG. 1.

At step 202, the method 200 includes receiving data packets including data associated with previous interactions of a first user. The data packets and data associated with previous interactions of the first user may be stored in a database (e.g., database 124 of FIG. 1) that is accessible by different systems such as target metric determination system 120 or party determination system 116.

At step 204, the method 200 includes determining at least one party to the previous interactions with whom the first user interacted at a level above a threshold. Step 204 may also include determining whether a classification code associated with each of the previous interactions is of a predetermined type. The classification code may indicate a classification of a party with whom each of the previous interactions occurred.

At step 206, the method 200 includes comparing the least one party to a plurality of parties identified in a target database to identify at least one potential target.

At step 208, the method 200 includes determining, for each of the at least one potential targets, a respective target metric by inputting the data packets into a machine learning model. Step 208 may further include obtaining information related to each target from one or more websites associated with each target in the target database. The obtained information may be inputted into the machine learning model along with the data packets to determine the respective target metric. The obtained information related to each target may include information related to providing gifts. The respective target metric may indicate an ease with which a second user may acquire an item (e.g., gift) intended for the first user from the at least one party.

At step 210, the method 200 includes providing an identification of the least one potential target to a user device associated with the first user.

At step 212, the method 200 includes receiving feedback regarding the identification. The feedback may include an indication that the first user rejects the at least one potential target received at step 210. The feedback may also include an indication that the first user approves of the at least one potential target. The feedback may also include an indication from the first user that one or more target metrics are incorrect, inaccurate, and/or incomplete. Alternatively, the feedback may include an indication that the target metrics are correct, accurate, and/or complete.

At step 214, the method 200 includes training the machine learning model based on the feedback. For example, if the feedback includes an indication that the first user rejects the at least one potential target, the machine learning model may use the feedback as an input and may learn that the potential target is not desirable as a potential target for at least one user.

The method 200 may include additional steps not shown in FIG. 2 such as using the trained model to refine the selection of the at least one potential target. For instance, a listing of potential targets determined using the trained model may benefit from the learning provided by the user 102 when identifying one or more potential target to exclude from the listing. In other words, the trained model may be tuned so as to better identify potential targets in future interactions of the user 102 that include new third parties not previously interacted with and/or third parties that the user 102 has previously interacted with.

In some embodiments, the method 200 may include providing the at least one potential target to a second user device associated with a second user. The method 200 may further include receiving an indication from the second user device that the second user has visited a website associated with the at least one potential target and further training the machine learning model based on the received indication. In some embodiments, the method 200 may include determining that the at least one party does not match any of the plurality of parties identified in the target database, and adding the at least one party to the target database. The method 200 may also include authenticating the user device associated with the first user. The authentication may allow the first user to communicate with a party determination system (e.g., party determination system 116 of FIG. 1) and/or a target metric determination system (e.g., target metric determination system 120 of FIG. 1).

One or more implementations disclosed herein include and/or are implemented using a machine learning model, e.g., one or more of target metric determination system 120, party determination system 116, etc., are implemented using a machine learning model (e.g., target metric machine learning model 122) and/or are used to train the machine learning model.

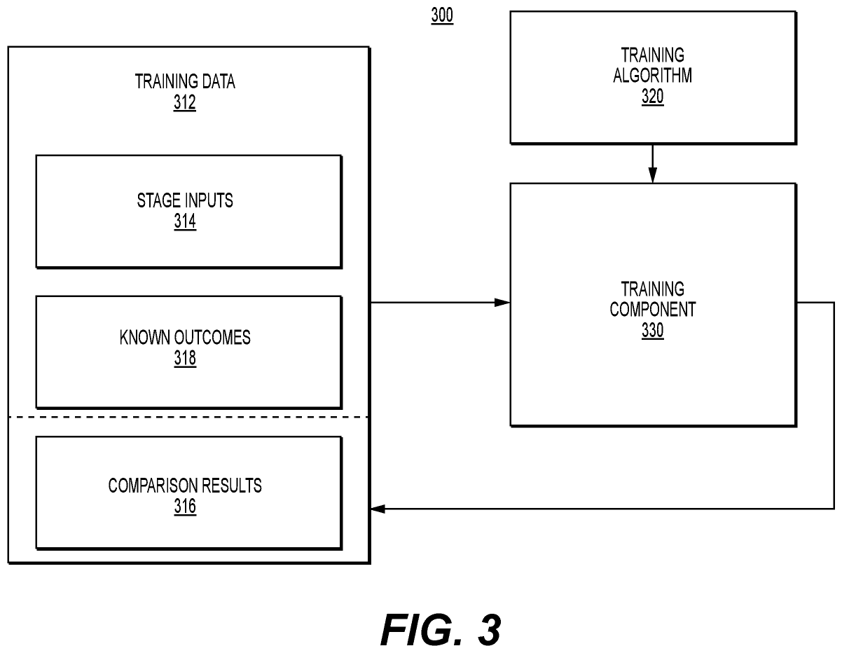

FIG. 3 is a flow chart 300 depicting how a machine learning model may be trained, in accordance with one or more embodiments. The training data 312 may include one or more of stage inputs 314 and the known outcomes 318 related to the machine learning model to be trained. The stage inputs 314 are from any applicable source including text, visual representations, data, values, comparisons, and stage outputs, e.g., one or more outputs from one or more steps from FIG. 2. The known outcomes 318 are included for the machine learning models generated based on supervised or semi-supervised training. An unsupervised machine learning model is not trained using the known outcomes 318. The known outcomes 318 includes known or desired outputs for future inputs similar to or in the same category as the stage inputs 314 that do not have corresponding known outputs.

The training data 312 and a training algorithm 320, e.g., one or more of the modules implemented using the machine learning model and/or are used to train the machine learning model, is provided to a training component 330 that applies the training data 312 to the training algorithm 320 to generate the machine learning model. According to an implementation, the training component 330 is provided comparison results 316 that compare a previous output of the corresponding machine learning model to apply the previous result to re-train the machine learning model. The comparison results 316 are used by the training component 330 to update the corresponding machine learning model. The training algorithm 320 utilizes machine learning networks and/or models including, but not limited to a deep learning network such as a transformer, Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

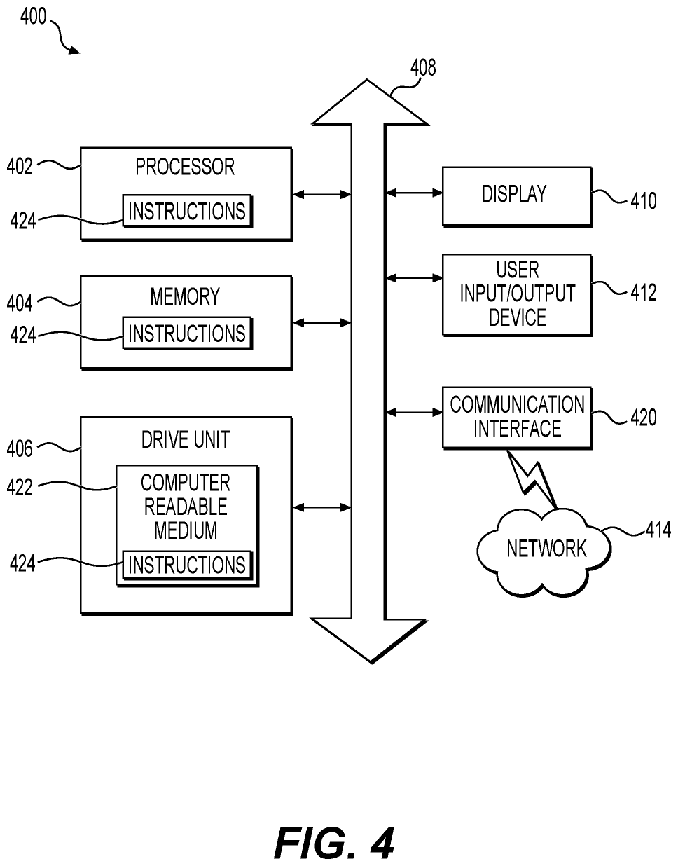

FIG. 4 depicts a simplified functional block diagram of a computer 400 that may be configured as a device for executing the methods disclosed here, according to exemplary embodiments of the present disclosure. For example, the computer 400 may be configured as a system according to exemplary embodiments of this disclosure. In various embodiments, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications (e.g., via network 414, which may be an example of network 110 of FIG. 1). The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for training a machine learning model by extracting one or more targets from records, the method comprising:
receiving, by at least one processor, data packets including data associated with previous interactions of a first user;
determining, by the at least one processor, at least one party to the previous interactions with whom the first user interacted at a level above a threshold;
comparing the at least one party to a plurality of parties identified in a target database to identify at least one potential target;
for each of the at least one potential targets, determining, by the at least one processor, a respective target metric by inputting the data packets into a machine learning model;
providing, by the at least one processor, an identification of the at least one potential target, with reference to the respective target metrics, to a user device associated with the first user;
receiving, via the user device, feedback regarding the identification; and
training the machine learning model based on the feedback.

2. The computer-implemented method of claim 1, wherein determining the respective target metric further comprises:
obtaining information related to each target from one or more websites associated with each target in the target database; and
inputting the information related to each target to the machine learning model along with the data packets to determine the respective target metric.

3. The computer-implemented method of claim 2, wherein the information related to each target comprises information related to providing gifts.

4. The computer-implemented method of claim 1, wherein determining the at least one party to the previous interactions with whom the first user interacted at the level above the threshold comprises:
determining whether a classification code associated with each of the previous interactions is of a predetermined type, the classification code indicating a classification of a party with whom each of the previous interactions occurred.

5. The computer-implemented method of claim 1, wherein the feedback regarding the identification comprises an indication that the first user rejects the at least one potential target.

6. The computer-implemented method of claim 1, wherein the respective target metric indicates an ease with which a second user may acquire an item intended for the first user from the at least one party.

7. The computer-implemented method of claim 1, further comprising:
providing, by the at least one processor, the at least one potential target to a second user device associated with a second user.

8. The computer-implemented method of claim 7, further comprising:
receiving an indication from the second user device that the second user has visited a website associated with the at least one potential target; and
further training the machine learning model based on the indication.

9. The computer-implemented method of claim 1, further comprising:
determining that the at least one party does not match any of the plurality of parties identified in the target database; and
adding the at least one party to the target database.

10. The computer-implemented method of claim 1, further comprising:
authenticating, by at least one processor, the user device associated with the first user.

11. A system for training a machine learning model by extracting one or more targets from records, the system comprising:
a memory storing instructions; and
a processor operatively connected to the memory and configured to execute the instructions to perform operations including:
receiving data packets including data associated with previous interactions of a first user;
determining at least one party to the previous interactions with whom the first user interacted at a level above a threshold;
comparing the at least one party to a plurality of parties identified in a target database to identify at least one potential target;
for each of the at least one potential targets, determining a respective target metric by inputting the data packets into a machine learning model;
providing an identification of the at least one potential target, with reference to the respective target metrics, to a user device associated with the first user;
receiving, via the user device, feedback regarding the identification; and
training the machine learning model based on the feedback.

12. The system of claim 11, wherein determining the respective target metric further comprises:
obtaining information related to each target from one or more websites associated with each target in the target database; and
inputting the information related to each target to the machine learning model along with the data packets to determine the respective target metric.

13. The system of claim 12, wherein the information related to each target comprises information related to providing gifts.

14. The system of claim 11, wherein determining the at least one party to the previous interactions with whom the first user interacted at the level above the threshold comprises:
determining whether a classification code associated with each of the previous interactions is of a predetermined type, the classification code indicating a classification of a party with whom each of the previous interactions occurred.

15. The system of claim 11, wherein the feedback regarding the identification comprises an indication that the first user rejects the at least one potential target.

16. The system of claim 11, wherein the respective target metric indicates an ease with which a second user may acquire an item intended for the first user from the at least one party.

17. The system of claim 11, wherein the processor is configured to execute the instructions to perform additional operations including:
providing the at least one potential target to a second user device associated with a second user.

18. The system of claim 17, wherein the processor is configured to execute the instructions to perform additional operations including:
receiving an indication from the second user device that the second user has visited a website associated with the at least one potential target; and
further training the machine learning model based on the indication.

19. The system of claim 11, wherein the processor is configured to execute the instructions to perform additional operations including:
determining that the at least one party does not match any of the plurality of parties identified in the target database; and
adding the at least one party to the target database.

20. A non-transitory computer readable medium storing instructions which, when executed by one or more processors, cause the one or more processors to perform operations for training a machine learning model by extracting one or more targets from records, the operations comprising:
receiving data packets including data associated with previous interactions of a first user;
determining at least one party to the previous interactions with whom the first user interacted at a level above a threshold;
comparing the at least one party to a plurality of parties identified in a target database to identify at least one potential target;
for each of the at least one potential targets, determining a respective target metric by inputting the data packets into a machine learning model;
providing an identification of the at least one potential target, with reference to the respective target metrics, to a user device associated with the first user;
receiving, via the user device, feedback regarding the identification;
training the machine learning model based on the feedback;
providing the at least one potential target to a second user device associated with a second user;
receiving an indication from the second user device that the second user has visited a website associated with the at least one potential target; and
further training the machine learning model based on the indication.
